(19) United States
(12) Patent Application Publication
(10) Pub. No.: US 2025/0239411 A1
(43) Pub. Date: Jul. 24, 2025

(54) ELECTRONIC COMPONENT

(71) Applicant: TDK CORPORATION, Tokyo (JP)

(72) Inventors: Masahiro IWAMA, Tokyo (JP); Toru ONOUE, Tokyo (JP); Yutaro ARAI, Tokyo (JP)

(73) Assignee: TDK CORPORATION, Tokyo (JP)

(21) Appl. No.: 18/962,410

(22) Filed: Nov. 27, 2024

(30) Foreign Application Priority Data
Jan. 24, 2024 (JP) 2024-008475

(51) Int. Cl. H01G 4/35; H01G 2/06; H01G 4/008; H01G 4/012; H01G 4/232; H01G 4/30

(52) U.S. Cl. CPC H01G 4/35; H01G 2/065; H01G 4/008; H01G 4/012; H01G 4/232; H01G 4/30

(57) ABSTRACT

A first main surface is curved at an end coupled to an end surface. An external electrode is disposed on the first main surface and the end surface. A distance T1 (μm), a distance H1 (μm), and a curvature radius R1 (μm) satisfy relations of

$$H 1 / 2 > T 1$$

$$and$$

$$R 1 > T 1 ,$$

the distance T1 being between an internal conductor, of a plurality of internal conductors, adjacent to the first main surface, and a plane in contact with the first main surface and parallel to a second main surface, in a direction perpendicular to the plane; the distance H1 being between an exposed end, of exposed ends, connected to the external electrode and closest to the plane, and the plane, in the direction perpendicular to the plane; and the curvature radius R1 being at the end, of the first main surface, coupled to the end surface.

### CROSS-REFERENCE TO RELATED APPLICATIONS

This application is based upon and claims the benefit of priority from Japanese Patent Application No. 2024-008475, filed on Jan. 24, 2024, the entire contents of which are incorporated herein by reference.

### BACKGROUND

### Field

The present disclosure relates to an electronic component.

### Description of the Related Art

Known electronic components include an element body, a plurality of external electrodes disposed on the element body, and a plurality of internal conductors disposed in the element body (for example, see Japanese Unexamined Utility Model Publication No. S59-138229). The element body includes a first main surface arranged to constitute a mounting surface, a second main surface opposing the first main surface, and an end surface coupling the first main surface and the second main surface. The plurality of internal conductors includes exposed ends exposed from the element body.

### SUMMARY

In a configuration in which an electronic component is solder-mounted on an electronic device, an external force acting on the electronic component from the electronic device may act as a stress on the element body. The electronic device includes, for example, a circuit board or an electronic component. The external force acts on the element body from, for example, a solder fillet formed during solder mounting through the external electrode. In this case, a crack may occur in the element body.

If the crack occurs in the element body, the crack may reach the internal conductor. The crack that has reached the internal conductor in the electronic component may result in deterioration of characteristics.

An object of one aspect of the present disclosure is to provide an electronic component that controls deterioration of characteristics even if a crack occurs in an element body.

An electronic component according to one aspect of the present disclosure includes an element body, a plurality of external electrodes disposed on the element body, and a plurality of internal conductors disposed in the element body and including exposed ends exposed from the element body. The element body includes a first main surface arranged to constitute a mounting surface, a second main surface opposing the first main surface, and an end surface coupling the first main surface and the second main surface. The first main surface is curved at an end coupled to the end surface. The plurality of external electrodes includes a first external electrode disposed on the first main surface and the end surface. The plurality of internal conductors includes a plurality of first internal conductors with the exposed ends connected to the first external electrode. A distance T1 (μm), a distance H1 (μm), and a curvature radius R1 (μm) satisfy relations of

$$H 1 / 2 > T 1$$

$$and$$

$$R 1 > T 1 ,$$

the distance T1 being between an internal conductor, of the plurality of internal conductors, adjacent to the first main surface, and a plane in contact with the first main surface and parallel to the second main surface, in a direction perpendicular to the plane; the distance H1 being between an exposed end, of the exposed ends, connected to the first external electrode and closest to the plane, and the plane, in the direction perpendicular to the plane; and the curvature radius R1 being at the end included in the first main surface and coupled to the end surface.

The result of researches and studies conducted by the present inventors has clarified the following matters.

The stress acts on the element body from an end included in the first external electrode and positioned on the first main surface, for example. In this case, a crack occurs in the element body from, as a starting point, a position corresponding to the end included in the first external electrode and positioned on the first main surface. For example, the crack grows from the above-described starting point toward the end surface in a direction intersecting the above-described plane. In a configuration in which an angle of the direction in which the crack grows in the element body relative to the plane is large, the crack tends to reach the internal conductor. In a configuration in which this angle is small, the crack tends not to reach the internal conductor.

The present inventors have focused on the direction in which the crack grows in the element body. As a result, the present inventors have found that the crack tends not to reach the inner conductor in a configuration in which a desired relation is satisfied by a distance being between an internal conductor, of the plurality of internal conductors, adjacent to the first main surface, and a plane in contact with the first main surface and parallel to the second main surface, in a direction perpendicular to the plane; a distance being between an exposed end, of the exposed ends, connected to the first external electrode and closest to the plane, and the plane, in the direction perpendicular to the plane; and a curvature radius being at the end included in the first main surface and coupled to the end surface. That is, in a configuration in which the distance T1 (μm), the distance H1 (μm), and the curvature radius R1 (μm) satisfy relations of

$$H1 / 2 > T 1$$

$$and$$

$$R 1 > T 1 ,$$

the crack growing in the element body tends not to reach the internal conductor.

Therefore, in the above-described one aspect, the crack tends not to reach the internal conductor even if the crack occurs in the element body. Consequently, the above-described one aspect controls deterioration of characteristics.

In the electronic component according to the above-described one aspect, the distance H1 (μm) and the curvature radius R1 (μm) may satisfy a relation of

$$H 1 > R 1 .$$

The result of researches and studies conducted by the present inventors also has clarified the following matters.

In an electronic component, an external electrode may include an underlayer disposed on an element body and a plating layer disposed on the underlayer. The plating layer is formed through a plating process. In the plating process, for example, the element body on which the underlayer is disposed is immersed in a plating solution. In this case, the plating solution may infiltrate into the element body. The plating solution infiltrates into the element body from, for example, an exposed end of an internal conductor or an interface between the exposed end and the element body. In the electronic component with the element body into which the plating solution has infiltrated, the characteristics may deteriorate.

In a configuration in which the first main surface is curved at the end coupled to the end surface, a thickness of the underlayer tends to decrease at the above-described end of the first main surface. In this case, the plating solution tends to infiltrate from a region corresponding to the above-described end of the first main surface in the underlayer.

The present inventors have focused on a path through which the plating solution infiltrates. As a result, the present inventors have found that the plating solution tends not to infiltrate into the element body in a configuration in which a desired relation is satisfied by the distance being between the exposed end, of the exposed ends, connected to the first external electrode and closest to the plane, and the plane, in the direction perpendicular to the plane, and the curvature radius being at the end included in the first main surface and coupled to the end surface. That is, in a configuration in which the distance H1 (μm) and the curvature radius R1 (μm) satisfy a relation of

$$H 1 > R 1 ,$$

the plating solution tends not to infiltrate into the element body.

Therefore, the configuration in which the distance H1 (μm) and the curvature radius R1 (μm) satisfy the relation of

$$H 1 > R 1$$

reliably controls the deterioration of characteristics.

In the electronic component according to the above-described one aspect, the end surface may be curved at an end coupled to the second main surface, and the first external electrode may be disposed on the second main surface. The curvature radius R1 may be larger than a curvature radius at the end included in the end surface and coupled to the second main surface.

In a configuration in which the curvature radius R1 is larger than the curvature radius at the end included in the end surface and coupled to the second main surface, the first main surface and the second main surface are reliably identified from each other. Therefore, in this configuration, the electronic component can be solder-mounted on the electronic device such that the first main surface reliably opposes the electronic device.

In the electronic component according to the above-described one aspect, the element body may include a side surface coupling the first main surface and the second main surface and adjacent to the end surface. The plurality of external electrodes may include a second external electrode disposed on the first main surface and the side surface. The plurality of internal conductors may include a plurality of second internal conductors with the exposed ends connected to the second external electrode. The distance T1 (μm) and a distance H2 (μm) may satisfy a relation of

$$H 2 / 2 > T 1 ,$$

the distance H2 being between an exposed end, of the exposed ends, connected to the second external electrode and closest to the plane, and the plane, in the direction perpendicular to the plane.

The result of researches and studies conducted by the present inventors also has clarified the following matters.

The stress acts on the element body from an end included in the second external electrode and positioned on the first main surface, for example. In this case, a crack occurs in the element body from, as a starting point, a position corresponding to the end included in the second external electrode and positioned on the first main surface. For example, the crack grows from the above-described starting point toward the side surface in a direction intersecting the above-described plane. In a configuration in which an angle of the direction in which the crack grows in the element body relative to the plane is large, the crack tends to reach the internal conductor. In a configuration in which this angle is small, the crack tends not to reach the internal conductor.

The present inventors have focused on the direction in which the crack caused by the second external electrode grows in the element body. As a result, the present inventors have found that the crack caused by the second external electrode tends not to reach the inner conductor in a configuration in which a desired relation is satisfied by a distance being between an internal conductor, of the plurality of internal conductors, adjacent to the first main surface, and a plane in contact with the first main surface and parallel to the second main surface, in a direction perpendicular to the plane, and a distance being between an exposed end, of the exposed ends, connected to the second external electrode and closest to the plane, and the plane, in the direction perpendicular to the plane. That is, in a configuration in which the distance T1 (μm) and the distance H2 (μm) satisfy the relation of

$$H 2 / 2 > T 1 ,$$

the crack that is caused by the second external electrode and grows in the element body tends not to reach the internal conductor.

Therefore, in a configuration in which the distance T1 (μm) and the distance H2 (μm) satisfy the relation of

$$H 2 / 2 > T 1 ,$$

the crack tends not to reach the internal conductor even if the crack caused by the second external electrode occurs in the element body. This configuration further controls the deterioration of characteristics.

In the electronic component according to the above-described one aspect, the first main surface may be curved at an end coupled to the side surface. The distance T1 (μm) and a curvature radius R2 (μm) may satisfy a relation of

$$R 2 > T 1 ,$$

the curvature radius R2 being at the end included in the first main surface and coupled to the side surface.

The present inventors have found that the crack caused by the second external electrode further tends not to reach the inner conductor in a configuration in which a desired relation is satisfied by a distance being between an internal conductor, of the plurality of internal conductors, adjacent to the first main surface, and a plane in contact with the first main surface and parallel to the second main surface, in a direction perpendicular to the plane, and a curvature radius being at an end included in the first main surface and coupled to the side surface. That is, in a configuration in which the distance T1 (μm) and the curvature radius R2 (μm) satisfy the relation of

$$R 2 > T 1 ,$$

the crack that is caused by the second external electrode and grows in the element body further tends not to reach the internal conductor.

Therefore, in a configuration in which the distance T1 (μm) and the curvature radius R2 (μm) satisfy the relation of

$$R 2 > T 1 ,$$

the crack further tends not to reach the internal conductor even if the crack caused by the second external electrode occurs in the element body. This configuration further controls the deterioration of characteristics.

In the electronic component according to the above-described one aspect, the distance H2 (μm) and the curvature radius R2 (μm) may satisfy a relation of

$$H 2 > R 2 .$$

The present inventors also have found that the plating solution tends not to infiltrate into the element body in a configuration in which a desired relation is satisfied by the distance being between the exposed end, of the exposed ends, connected to the second external electrode and closest to the plane, and the plane, in the direction perpendicular to the plane, and the curvature radius being at the end included in the first main surface and coupled to the side surface. That is, in a configuration in which the distance H2 (μm) and the curvature radius R2 (μm) satisfy the relation of

$$H 2 > R 2 ,$$

the plating solution tends not to infiltrate into the element body.

Therefore, the configuration in which the distance H2 (μm) and the curvature radius R2 (μm) satisfy the relation of

$$H 2 > R 2$$

reliably controls the deterioration of characteristics.

In the electronic component according to the above-described one aspect, the side surface may be curved at an end coupled to the second main surface, and the second external electrode may be disposed on the second main surface. The curvature radius R2 may be larger than a curvature radius at the end included in the side surface and coupled to the second main surface.

In a configuration in which the curvature radius R2 is larger than the curvature radius at the end included in the side surface and coupled to the second main surface, the first main surface and the second main surface are reliably identified from each other. Therefore, in this configuration, the electronic component can be solder-mounted on the electronic device such that the first main surface further reliably opposes the electronic device.

In the electronic component according to the above-described one aspect, the distance T1 (μm) may satisfy the relation of

$$T 1 > 45 .$$

In a manufacturing process, chipping may occur in the element body. For example, an impact is applied to the element body because of collision between the element bodies or collision between the element body and manufacturing equipment other than the element body. An impact applied to the element body increases a possibility that the chipping occurs in the element body.

The present inventors have focused on a configuration in which chipping may occur. As a result, the present inventors have found that the chipping tends not to occur in the element body in a configuration in which a desired relation is satisfied by a distance being between an internal conductor, of the plurality of internal conductors, adjacent to the first main surface, and a plane in contact with the first main surface and parallel to the second main surface, in a direction perpendicular to the plane. That is, in a configuration in which the distance T1 (μm) satisfies the relation of

$$T 1 > 45 ,$$

the chipping tends not to occur in the element body.

Therefore, a configuration in which the distance T1 (μm) satisfies the relation of

$$T 1 > 45$$

controls occurrence of the chipping in the element body.

In the electronic component according to the above-described aspect, the plurality of internal conductors may oppose each other in a direction in which the first main surface and the second main surface oppose each other.

In a configuration in which the plurality of internal conductors oppose each other in the direction in which the first main surface and the second main surface oppose each other, the characteristics tend to deteriorate if the crack occurs in the element body. However, as described above, the crack tends not to reach the internal conductor even if the crack occurs in the element body. Therefore, in this configuration, the deterioration of characteristics is reliably controlled.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view illustrating a multilayer feedthrough capacitor according to an embodiment;

FIG. 2 is a diagram illustrating a cross-sectional configuration of the multilayer feedthrough capacitor according to the present embodiment;

FIG. 3 is a diagram illustrating another cross-sectional configuration of the multilayer feedthrough capacitor according to the present embodiment;

FIG. 4 is a diagram illustrating another cross-sectional configuration of the multilayer feedthrough capacitor according to the present embodiment;

FIG. 5 is a diagram illustrating another cross-sectional configuration of the multilayer feedthrough capacitor according to the present embodiment;

FIG. 6 is a table illustrating test results of samples;

FIG. 7 is a table illustrating test results of samples;

FIG. 8 is a diagram illustrating a cross-sectional configuration of an electronic component device;

FIG. 9 is a diagram illustrating another cross-sectional configuration of the electronic component device; and

FIG. 10 is a diagram illustrating a cross-sectional configuration of a multilayer capacitor according to a modification of the present embodiment.

### DETAILED DESCRIPTION

In the following description, with reference to the drawings, the same reference numbers are assigned to the same components or to similar components having the same function, and overlapping description is omitted.

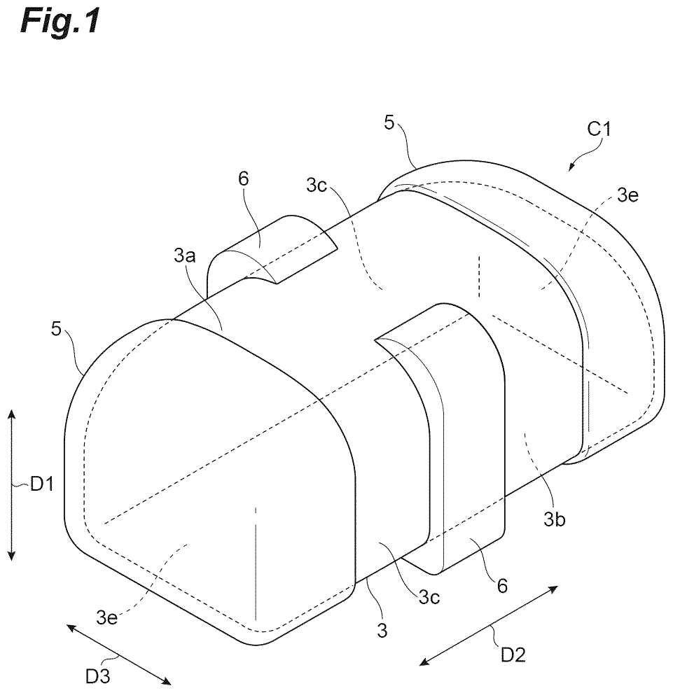

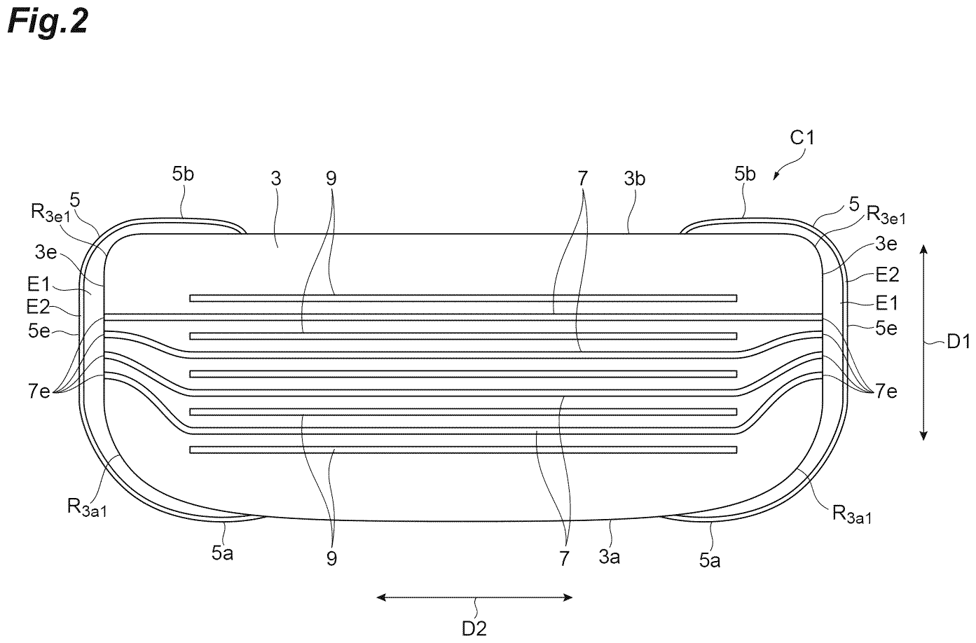

A configuration of a multilayer feedthrough capacitor C1 according to the present embodiment will be described with reference to FIGS. 1 to 5. FIG. 1 is a perspective view illustrating a multilayer feedthrough capacitor according to the present embodiment. FIGS. 2, 3, 4, and 5 are diagrams illustrating cross-sectional configurations of the multilayer feedthrough capacitor according to the present embodiment. In FIGS. 2, 3, 4, and 5, hatching indicating the cross section is not illustrated.

An electronic component includes, for example, a multilayer feedthrough capacitor C1.

As illustrated in FIGS. 1 to 3, the multilayer feedthrough capacitor C1 includes an element body 3 of a rectangular parallelepiped shape, and a plurality of external electrodes disposed on the element body 3. The plurality of external electrodes includes, for example, a pair of external electrodes 5 and a pair of external electrodes 6. The pair of external electrodes 5 and the pair of external electrodes 6 are separated from each other. Each external electrode 5 is included in, for example, a signal terminal electrode, and each external electrode 6 is included in, for example, a grounding terminal electrode. The rectangular parallelepiped shape includes a rectangular parallelepiped shape with each of portions corresponding to corners and ridges rounded. In the element body 3, each of the portions corresponding to the corners and the ridges is rounded to be curved. For example, the element body 3 is subjected to round chamfering.

The element body 3 includes a pair of main surfaces 3a and 3b opposing each other, a pair of side surfaces 3c opposing each other, and a pair of end surfaces 3e opposing each other. The pair of main surfaces 3a and 3b, the pair of side surfaces 3c, and the pair of end surfaces 3e each have a rectangular shape. A direction in which the pair of main surfaces 3a and 3b opposes each other includes a first direction D1. A direction in which the pair of side surfaces 3c opposes each other includes a third direction D3. A direction in which the pair of end surfaces 3c opposes each other includes a second direction D2.

The multilayer feedthrough capacitor C1 is solder-mounted on an electronic device. The electronic device includes, for example, a circuit board or an electronic component. In the multilayer feedthrough capacitor C1, the main surface 3a opposes the electronic device. The main surface 3a is arranged to constitute a mounting surface. The main surface 3a is the mounting surface. For example, when the main surface 3a includes a first main surface, the main surface 3b includes a second main surface.

The first direction D1 includes a direction perpendicular to the main surfaces 3a and 3b, and is perpendicular to the third direction D3. The second direction D2 includes a direction parallel to each of the main surfaces 3a and 3b, and each of the side surfaces 3c, and is perpendicular to the first direction D1 and the third direction D3. The third direction D3 includes a direction perpendicular to the side surfaces 3c, and the second direction D2 includes a direction perpendicular to the end surfaces 3e.

The pair of side surfaces 3c extends in the first direction D1 to couple the pair of main surfaces 3a and 3b. The pair of side surfaces 3c extends in the second direction D2. The pair of end surfaces 3e extends in the first direction D1 to couple the pair of main surfaces 3a and 3b. The pair of end surfaces 3e extends in the third direction D3.

Each of the end surfaces 3e couples the main surface 3a and the main surface 3b. Each of the end surfaces 3e and the main surface 3a are adjacent to each other, and each of the end surfaces 3e and the main surface 3b are adjacent to each other. Each of the side surfaces 3c couples the main surface 3a and the main surface 3b. Each of the side surfaces 3c and the main surface 3a are adjacent to each other, and each of the side surfaces 3c and the main surface 3b are adjacent to each other. Each of the end surfaces 3e and each of the side surfaces 3c are adjacent to each other.

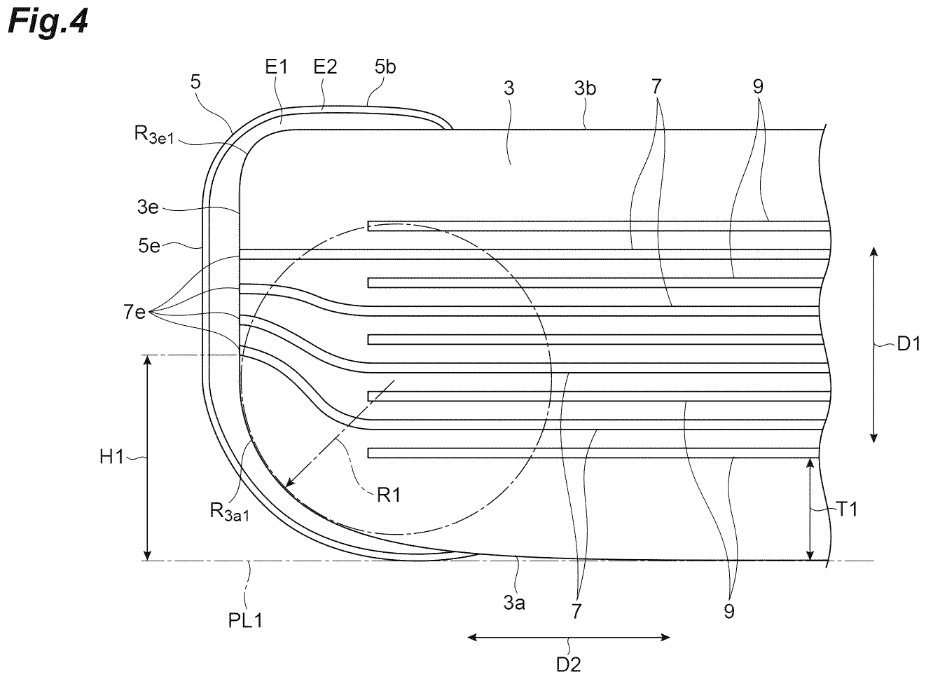

As illustrated in FIG. 4, the main surface 3a is curved at an end coupled to the end surface 3e. The main surface 3a includes a curved region R₃ₐ₁ at the end coupled to the end surface 3e. The region R₃ₐ₁ includes a curved surface having a predetermined curvature radius. The end surface 3e is curved at an end coupled to the main surface 3b. The end surface 3e includes a curved region R₃ₑ₁ at the end coupled to the main surface 3b. The region R₃ₑ₁ includes a curved surface having a predetermined curvature radius. For example, the main surface 3b is substantially planar.

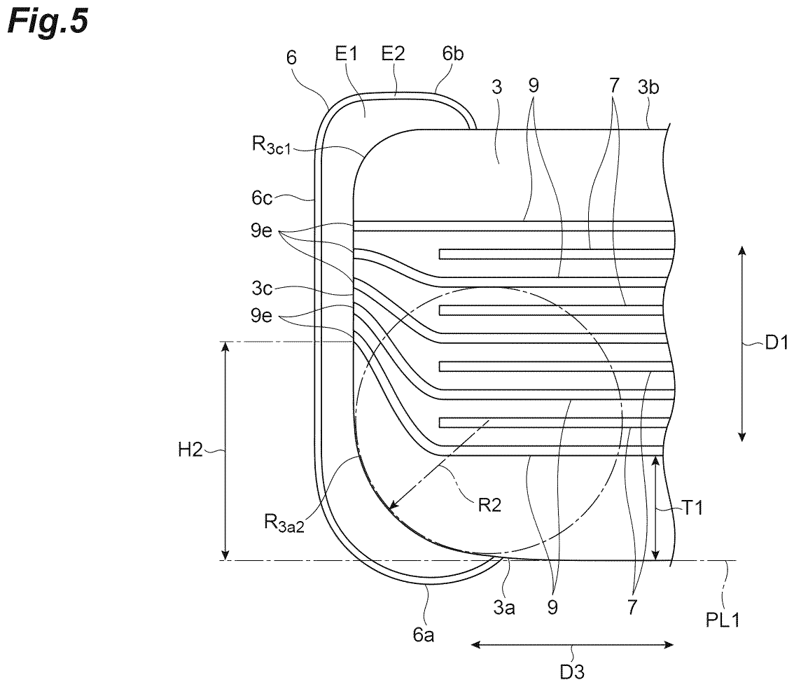

As illustrated in FIG. 5, the main surface 3a is curved at an end coupled to the side surface 3c. The main surface 3a includes a curved region R₃ₐ₂ at the end coupled to the side surface 3c. The region R₃ₐ₂ includes a curved surface having a predetermined curvature radius. The side surface 3c is curved at an end coupled to the main surface 3b. The side surface 3c includes a curved region R₃ₑ₁ at the end coupled to the main surface 3b. The region R₃ₑ₁ includes a curved surface having a predetermined curvature radius.

For example, a length of the element body 3 in the second direction D2 is larger than a length of the element body 3 in the first direction D1, and is larger than a length of the element body 3 in the third direction D3. The second direction D2 includes a longitudinal direction of the element body 3. The length of the element body 3 in the first direction D1 and the length of the element body 3 in the third direction D3 may be equal to each other. The length of the element body 3 in the first direction D1 and the length of the element body 3 in the third direction D3 may be different from each other.

The length of the element body 3 in the first direction D1 includes a height of the element body 3. The length of the element body 3 in the third direction D3 includes a width of the element body 3. The length of the element body 3 in the second direction D2 is the length of the element body 3. For example, the height of the element body 3 is 0.2 to 1.3 mm, the width of the element body 3 is 0.5 to 1.6 mm, and the length of the element body 3 is 1.0 to 3.2 mm. For example, the height of the element body 3 is 0.85 mm, the width of the element body 3 is 1.2 mm, and the length of the element body 3 is 2.0 mm.

The element body 3 is configured through laminating a plurality of dielectric layers in the first direction D1. The element body 3 includes the plurality of laminated dielectric layers. In the element body 3, a lamination direction of the plurality of dielectric layers coincides with the first direction D1. Each of the dielectric layers includes, for example, a sintered body of a ceramic green sheet including a dielectric material. The dielectric material includes a dielectric ceramic. The dielectric ceramic includes, for example, a BaTiO₃-based dielectric ceramic, Ba(Ti, Zr)O₃-based dielectric ceramic, or (Ba, Ca)TiO₃-based dielectric ceramic. In the actual element body 3, the dielectric layers are integrated to such an extent that a boundary between the dielectric layers cannot be visually recognized.

As illustrated in FIGS. 1 and 2, the pair of external electrodes 5 is disposed at both end portions of the element body 3 in the second direction D2. Each of the external electrodes 5 is disposed on a corresponding end surface 3e of the pair of end surfaces 3e. For example, each of the external electrodes 5 is disposed on the pair of main surfaces 3a and 3b, the pair of side surfaces 3c, and one end surface 3e. Each external electrode 5 includes a plurality of electrode portions. As illustrated in FIG. 4, the plurality of electrode portions includes an electrode portion 5a disposed on the main surface 3a, an electrode portion 5b disposed on the main surface 3b, and an electrode portion 5e disposed on the end surface 3e. The plurality of electrode portions may include electrode portions disposed on each of the side surfaces 3c. The plurality of electrode portions may not include the electrode portion 5b. Each of the external electrodes 5 is disposed at least on the main surface 3a and the corresponding end surface 3e described above.

The electrode portion 5a covers a partial region of the main surface 3a. The electrode portion 5a is in contact with the above-described partial region of the main surface 3a. The electrode portion 5a is in direct contact with the element body 3. The main surface 3a is covered with the electrode portion 5a at the above-described partial region. The above-described partial region of the main surface 3a is positioned closer to the end surface 3e. The above-described partial region of the main surface 3a includes a curved end, that is, the region R₃ₐ₁. The electrode portion 5a covers the region R₃ₐ₁.

The electrode portion 5b covers a partial region of the main surface 3b. The electrode portion 5b is in contact with the above-described partial region of the main surface 3b. The electrode portion 5b is in direct contact with the element body 3. The main surface 3b is covered with the electrode portion 5b at the above-described partial region. The above-described partial region of the main surface 3b is positioned closer to the end surface 3e.

The electrode portion 5e covers the end surface 3e. The electrode portion 5e covers, for example, the entire end surface 3e. The electrode portion 5e is in contact with the end surface 3e. The electrode portion 5e is in direct contact with the element body 3. The electrode portion 5e covers the region R₃ₑ₁ included in the end surface 3e.

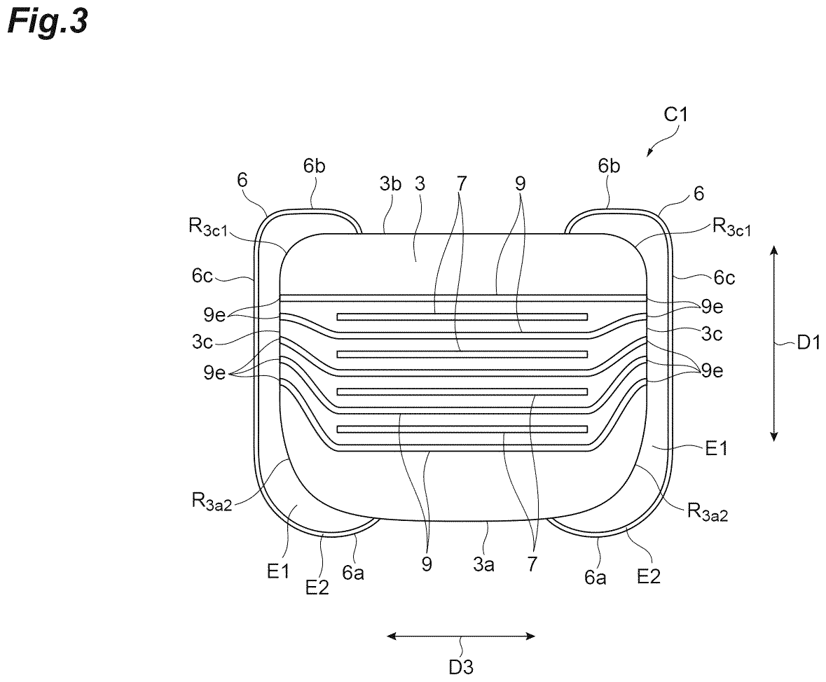

As illustrated in FIG. 1, the pair of external electrodes 6 is disposed at a center portion of the element body 3 in the second direction D2, and is positioned between the pair of external electrodes 5 in the second direction D2. As illustrated in FIG. 3, the pair of external electrodes 6 is disposed at both sides of the element body 3 in the third direction D3. Each of the external electrodes 6 is disposed on a corresponding side surface 3c of the pair of side surfaces 3c. For example, each of the external electrodes 6 is disposed on the pair of main surfaces 3a and 3b, and one side surface 3c. Each external electrode 6 includes a plurality of electrode portions. As illustrated in FIG. 5, the plurality of electrode portions includes an electrode portion 6a disposed on the main surface 3a, an electrode portion 6b disposed on the main surface 3b, and an electrode portion 6c disposed on the side surface 3c. The plurality of electrode portions may not include the electrode portion 6b. Each external electrode 6 is disposed at least on the main surface 3a and the corresponding side surface 3c described above. For example, when the external electrodes 5 include a first external electrode, the external electrodes 6 include a second external electrode.

The electrode portion 6a covers a partial region of the main surface 3a. The electrode portion 6a is in contact with the above-described partial region of the main surface 3a. The electrode portion 6a is in direct contact with the element body 3. The main surface 3a is covered with the electrode portion 6a at the above-described partial region. The above-described partial region of the main surface 3a is positioned closer to the side surface 3c. The above-described partial region of the main surface 3a includes a curved end, that is, the region R₃ₐ₂. The electrode portion 6a covers the region R₃ₐ₂.

The electrode portion 6b covers a partial region of the main surface 3b. The electrode portion 6b is in contact with the above-described partial region of the main surface 3b. The electrode portion 6b is in direct contact with the element body 3. The main surface 3b is covered with the electrode portion 6b at the above-described partial region. The above-described partial region of the main surface 3b is positioned closer to the side surface 3c.

The electrode portion 6c covers a partial region of the side surface 3c. The electrode portion 6c is in contact with the above-described partial region of the side surface 3c. The electrode portion 6c is in direct contact with the element body 3. The side surface 3c is covered with the electrode portion 6c at the above-described partial region. The above-described partial region of the side surface 3c is positioned substantially at the center of the side surface 3c in the second direction D2. The above-described partial region of the side surface 3c includes a curved end, that is, the region R_{3c1}. The electrode portion 6c covers the region R_{3c1}.

Each of the pair of external electrodes 5 is disposed on, for example, five surfaces including the pair of main surfaces 3a and 3b, the pair of side surfaces 3c, and one end surface 3e. Each of the pair of external electrodes 6 is disposed on, for example, three surfaces including the pair of main surfaces 3a and 3b, and one side surface 3c. As illustrated in FIGS. 4 and 5, each of the external electrodes 5 and 6 includes, for example, a first electrode layer E1 and a second electrode layer E2. The plurality of electrode portions included in each of the external electrodes 5 and 6 includes, for example, the first electrode layer E1 and the second electrode layer E2.

The first electrode layer E1 is formed from sintering electrically conductive paste applied onto the surface of the element body 3. The first electrode layer E1 is formed from sintering a metal component included in the electrically conductive paste. The metal component included in the electrically conductive paste includes, for example, metal particles. The first electrode layer E1 includes a sintered metal layer. The first electrode layer E1 includes a sintered metal layer formed on the element body 3. For example, the first electrode layer E1 includes a sintered metal layer made of Cu. The first electrode layer E1 may include a sintered metal layer made of Ni. The first electrode layer E1 includes a base metal. The electrically conductive paste includes, for example, particles made of Cu or Ni, a glass component, an organic binder, and an organic solvent.

The second electrode layer E2 is formed on the first electrode layer E1 by a plating process. The second electrode layer E2 may have a multilayer structure. In a configuration in which the second electrode layer E2 has a multilayer structure, the second electrode layer E2 includes, for example, a Ni plating layer and a solder plating layer. The Ni plating layer is formed on the first electrode layer E1. The solder plating layer is formed on the Ni plating layer. The solder plating layer covers the Ni plating layer. The Ni plating layer has better solder leach resistance than the metal included in the first electrode layer E1. The second electrode layer E2 may include an Sn plating layer, a Cu plating layer, or an Au plating layer instead of the Ni plating layer. The solder plating layer includes, for example, a Sn plating layer, a Sn—Ag alloy plating layer, a Sn—Bi alloy plating layer, or a Sn—Cu alloy plating layer. The first electrode layer E1 includes an underlayer for forming the second electrode layer E2.

The multilayer feedthrough capacitor C1 includes a plurality of internal conductors disposed in the element body 3. As illustrated in FIGS. 2 to 5, the plurality of internal conductors includes a plurality of internal electrodes 7 and a plurality of internal electrodes 9. The internal electrodes 7 and the internal electrodes 9 are disposed at different positions (layers) in the first direction D1. In the element body 3, the internal electrodes 7 and the internal electrodes 9 oppose each other with distances in the first direction D1. The plurality of internal electrodes 7 and the plurality of internal electrodes 9 are disposed alternately in the first direction D1. The internal electrodes 7 and the internal electrodes 9 have different polarities from each other. Each of the internal electrodes 7 and 9 is positioned in a plane substantially parallel to the main surface 3b.

Each of the internal electrodes 7 and 9 includes an electrically conductive material commonly used as an internal conductor of a multilayer electronic component. The electrically conductive material includes, for example, a base metal. The electrically conductive material includes, for example, Ni or Cu. Each of the internal electrodes 7 and 9 is configured as, for example, a sintered body of an electrically conductive paste containing the electrically conductive material described above. In the multilayer feedthrough capacitor C1, each of the internal electrodes 7 and 9 includes, for example, Ni.

The internal electrodes 7 are exposed at the pair of end surfaces 3e. Each internal electrode 7 includes a pair of ends 7e. Each of the pair of ends 7e is exposed at the corresponding end surface 3e of the pair of end surfaces 3e. The pair of ends 7e is exposed from the element body 3. Each end 7e includes an exposed end. The internal electrodes 7 are not exposed at the pair of main surfaces 3a and 3b, and the pair of side surfaces 3c.

Each of the pair of ends 7e is connected to a corresponding external electrode 5 of the pair of external electrodes 5. For example, each of the pair of ends 7e is connected to the electrode portion Se of the corresponding external electrode 5. Each of the pair of ends 7e is covered with the corresponding external electrode 5 and is directly connected to the corresponding external electrode 5. The plurality of internal electrodes 7 is physically and electrically connected to the pair of external electrodes 5.

The internal electrodes 9 are exposed at the pair of side surfaces 3c. Each internal electrode 9 includes a pair of ends 9e. Each of the pair of ends 9e is exposed at the corresponding side surface 3c of the pair of side surfaces 3c. The pair of ends 9e is exposed from the element body 3. Each end 9e includes an exposed end. The internal electrodes 9 are not exposed at the pair of main surfaces 3a and 3b, and the pair of end surfaces 3e.

Each of the pair of ends 9e is connected to a corresponding external electrode 6 of the pair of external electrodes 6. For example, each of the pair of ends 9e is connected to the electrode portion 6e of the corresponding external electrode 6. Each of the pair of ends 9e is covered with the corresponding external electrode 6 and is directly connected to the corresponding external electrode 6. The plurality of internal electrodes 9 is physically and electrically connected to the pair of external electrodes 6. For example, when the internal electrodes 7 include a first internal electrode, the internal electrodes 9 include a second internal electrode.

In the multilayer feedthrough capacitor C1, the internal electrode 9, of the plurality of internal electrodes 9, closest to the main surface 3a is adjacent to the main surface 3a. the internal electrode 9, out of the plurality of internal electrodes 9, closest to the main surface 3b is adjacent to the main surface 3b. The plurality of internal electrodes 9 includes a pair of outermost internal conductors, of the plurality of internal conductors, positioned outermost in the first direction D1.

The plurality of internal electrodes 7 may include a pair of outermost internal conductors, of the plurality of internal conductors, positioned outermost in the first direction D1. In a configuration in which the plurality of internal electrodes 7 includes the pair of outermost internal conductors, the internal electrode 7, of the plurality of internal electrodes 7, closest to the main surface 3a is adjacent to the main surface 3a, and the internal electrode 7, of the plurality of internal electrodes 7, closest to the main surface 3b is adjacent to the main surface 3b. The internal electrode 7 may be adjacent to the main surface 3a, and the internal electrode 9 may be adjacent to the main surface 3b. The internal electrode 9 may be adjacent to the main surface 3a, and the internal electrode 7 may be adjacent to the main surface 3b.

A configuration of the multilayer feedthrough capacitor C1 will be described with reference to FIGS. 4 and 5. As described above, the multilayer feedthrough capacitor C1 includes the element body 3, the plurality of external electrodes, and the plurality of internal conductors.

As illustrated in FIG. 4, the element body 3 includes the main surface 3a arranged to constitute the mounting surface, the main surface 3b opposing the main surface 3a, and the end surface 3e coupled the main surface 3a and the main surface 3b. The plurality of external electrodes is disposed on the element body 3. The plurality of internal electrodes are disposed in the element body 3 and include the exposed ends exposed from the element body 3. The main surface 3a is curved at the end coupled to the end surface 3e. The plurality of external electrodes includes the external electrode 5 disposed on the main surface 3a and the end surface 3e. The plurality of internal conductors includes the plurality of internal electrodes 7 with each of the ends 7e connected to the external electrode 5. The plurality of internal conductors includes the internal electrode 9 adjacent to the main surface 3a.

A distance T1 (μm), a distance H1 (μm), and a curvature radius R1 (μm) satisfy relations of

$$H 1 / 2 > T 1$$

$$and$$

$$R 1 > T 1.$$

The distance T1 is defined by a distance between the internal electrode 9 adjacent to the main surface 3a and a plane PL1, in a direction perpendicular to the plane PL1. The plane PL1 is in contact with the main surface 3a and is parallel to the main surface 3b. The direction perpendicular to the plane PL1 includes, for example, the first direction D1. The distance H1 is defined by a distance between the end 7e, of the ends 7e connected to the external electrode 5, closest to the plane PL1, and the plane PL1, in the direction perpendicular to the plane PL1. The curvature radius R1 is defined by a curvature radius at the end included in the main surface 3a and coupled to the end surface 3e. The curvature radius R1 is defined by, for example, a curvature radius of the region R₃ₐ₁.

The distance H1 (μm) and the curvature radius R1 (μm) may satisfy a relation of

$$H 1 > R 1 .$$

The distance T1 (μm) may satisfy a relation of

$$T 1 > 45 .$$

As illustrated in FIG. 5, the element body 3 includes the side surface 3c coupling the main surface 3a and the main surface 3b and adjacent to the end surface 3e. The plurality of external electrodes includes the external electrode 6 disposed on the main surface 3a and the side surface 3c. The plurality of internal conductors includes the plurality of internal electrodes 9 with each of the ends 9e connected to the external electrode 6. The main surface 3a is curved at the end coupled to the side surface 3c. The plurality of internal conductors includes the internal electrode 9 adjacent to the main surface 3a.

The distance T1 (μm) and a distance H2 (μm) may satisfy a relation of

$$H 2 / 2 > T 1 .$$

The distance H2 is defined by a distance between the end 9e, of the ends 9e connected to the external electrode 6, closest to the plane PL1, and the plane PL1, in the direction perpendicular to the plane PL1.

The distance T1 (μm) and a curvature radius R2 (μm) may satisfy a relation of

$$R 2 > T 1.$$

The curvature radius R2 (μm) is defined by a curvature radius at the end included in the main surface 3a and coupled to the side surface 3c. The curvature radius R2 is defined by, for example, a curvature radius of the region R₃ₐ₂.

The distance H2 (μm) and the curvature radius R2 (μm) may satisfy a relation of

$$H 2 > R 2 .$$

As illustrated in FIG. 4, the end surface 3e is curved at the end coupled to the main surface 3b. The curvature radius R1 may be larger than a curvature radius at the end included in the end surface 3e and coupled to the main surface 3b. The above-described curvature radius of the end surface 3e is defined by, for example, a curvature radius of the region R₃ₑ₁.

As illustrated in FIG. 5, the side surface 3c is curved at the end coupled to the main surface 3b. The curvature radius R2 may be larger than the curvature radius at the end included in the side surface 3c and coupled to the main surface 3a. The above-described curvature radius of the side surface 3c is defined by, for example, a curvature radius of the region R₃ₑ₁.

The distance T1, the distance H1, and the curvature radius R1 can be obtained, for example, as follows.

A cross-sectional photograph of the element body 3 is acquired. The cross-sectional photograph is a photograph of a cross-section of the multilayer feedthrough capacitor C1 when cut along a plane perpendicular to the main surface 3a and the end surface 3e. The cross-sectional photograph is, for example, a photograph of a cross-section of the multilayer feedthrough capacitor C1 when cut along a plane parallel to the pair of side surfaces 3c and equidistant from the pair of side surfaces 3c. The distance T1, the distance H1, and the curvature radius R1 are obtained from the acquired cross-sectional photograph.

The distance H2 and the curvature radius R2 can be obtained, for example, as follows.

A cross-sectional photograph of the element body 3 is acquired. The cross-sectional photograph is a photograph of a cross-section of the multilayer feedthrough capacitor C1 when cut along a plane perpendicular to the main surface 3a and the side surface 3c. The cross-sectional photograph is, for example, a photograph of a cross-section of the multilayer feedthrough capacitor C1 when cut along a plane parallel to the pair of end surfaces 3e and equidistant from the pair of end surfaces 3e. The distance H2 and the curvature radius R2 are obtained from the acquired cross-sectional photograph.

Next, the relations between the distance T1, the distance H1, and the curvature radius R1 will be described in detail.

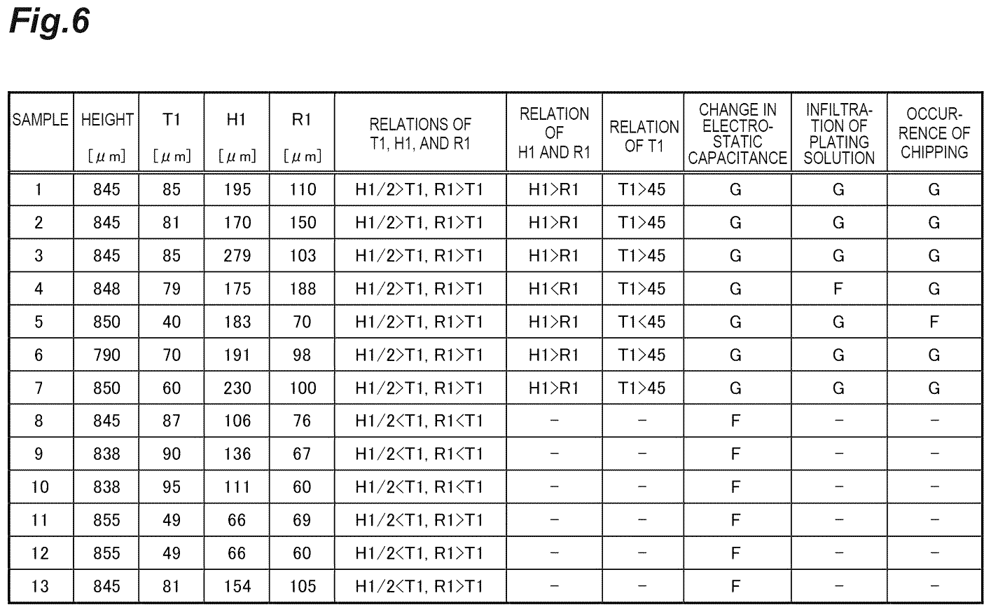

In order to clarify the relations between the distance T1, the distance H1, and the curvature radius R1, the present inventors conducted the following test. In this test, the present inventors prepared samples 1 to 13 with different distance T1, distance H1, and curvature radius R1, and confirmed changes in characteristics, infiltration of a plating solution, and occurrence of chipping, in each of the samples 1 to 13. The results are illustrated in FIG. 6. FIG. 6 is a table illustrating the test results of the samples.

Each of the samples 1 to 13 is a lot including a plurality of specimens. The specimens of the samples 1 to 13 are multilayer feedthrough capacitors having the same configuration as each other, except that the distance T1, the distance H1, and the curvature radius R1 are different between the specimens, and the height of the element body 3 (length of the element body 3 in the first direction D1) and the number of the plurality of internal conductors are different between the specimens. In the specimens of the samples 1 to 13, the length of the element body 3 is 2.0 mm, and the width of the element body 3 is 1.2 mm.

In each specimen of the sample 1, the height of the element body 3 is 845 μm, the distance T1 is 85 μm, the distance H1 is 195 μm, and the curvature radius R1 is 110 μm.

In each specimen of the sample 2, the height of the element body 3 is 845 μm, the distance T1 is 81 μm, the distance H1 is 170 μm, and the curvature radius R1 is 150 μm.

In each specimen of the sample 3, the height of the element body 3 is 845 μm, the distance T1 is 85 μm, the distance H1 is 279 μm, and the curvature radius R1 is 103 μm.

In each specimen of the sample 4, the height of the element body 3 is 848 μm, the distance T1 is 79 μm, the distance H1 is 175 μm, and the curvature radius R1 is 188 μm.

In each specimen of the sample 5, the height of the element body 3 is 850 μm, the distance T1 is 40 μm, the distance H1 is 183 μm, and the curvature radius R1 is 70 μm.

In each specimen of the sample 6, the height of the element body 3 is 790 μm, the distance T1 is 70 μm, the distance H1 is 191 μm, and the curvature radius R1 is 98 μm.

In each specimen of the sample 7, the height of the element body 3 is 850 μm, the distance T1 is 60 μm, the distance H1 is 230 μm, and the curvature radius R1 is 100 μm.

In each specimen of the sample 8, the height of the element body 3 is 845 μm, the distance T1 is 87 μm, the distance H1 is 106 μm, and the curvature radius R1 is 76 μm.

In each specimen of the sample 9, the height of the element body 3 is 838 μm, the distance T1 is 90 μm, the distance H1 is 136 μm, and the curvature radius R1 is 67 μm.

In each specimen of the sample 10, the height of the element body 3 is 838 μm, the distance T1 is 95 μm, the distance H1 is 111 μm, and the curvature radius R1 is 60 μm.

In each specimen of the sample 11, the height of the element body 3 is 855 μm, the distance T1 is 49 μm, the distance H1 is 166 μm, and the curvature radius R1 is 69 μm.

In each specimen of the sample 12, the height of the element body 3 is 855 μm, the distance T1 is 49 μm, the distance H1 is 166 μm, and the curvature radius R1 is 60 μm.

In each specimen of the sample 13, the height of the element body 3 is 845 μm, the distance T1 is 81 μm, the distance H1 is 154 μm, and the curvature radius R1 is 105 μm.

The values of the distance T1, the distance H1, and the curvature radius R1 were obtained from one specimen randomly selected from the plurality of specimens in each of the samples 1 to 13 according to the above-described method.

The changes in characteristics are confirmed as follows.

In each of the samples 1 to 13, one specimen is randomly selected from the plurality of specimens. An electrostatic capacitance of the selected specimen is measured. A flexural strength test is conducted on the specimen whose capacitance has been measured. After the flexural strength test, the electrostatic capacitance of the specimen is measured again. The rate of change in the electrostatic capacitance before and after conducting the flexural strength test is obtained based on the measurement result of the electrostatic capacitance. For a specimen having a rate of change in the electrostatic capacitance of less than 5%, a situation of change in characteristics is determined as “Good (G)”. For a specimen having a rate of change in the electrostatic capacitance of 5% or more, a situation of change in characteristics is determined as “Fail (F)”. A multilayer feedthrough capacitor having a rate of change in the electrostatic capacitance of less than 5% tends to be suitable for practical use.

The flexural strength test is conducted as follows.

The selected specimen is solder-mounted on a center portion of a test substrate (glass epoxy substrate). The size of the test substrate is 100 mm×40 mm, and the thickness of the test substrate is 1.0 mm. The test substrate with the specimen solder-mounted is placed on two supports arranged in parallel with a spacing of 90 mm. The test substrate is placed such that a surface on which the specimen is solder-mounted faces downward. Subsequently, flexural stress is applied to the center portion of the test substrate from the backside of the surface on which the specimen is solder-mounted, so that the flexural amount of the test substrate reaches a desired value. In this test, the flexural amount of the test substrate is 15 mm.

The infiltration of the plating solution and the occurrence of chipping are confirmed by observing the cross-section of the specimen when obtaining the values of the distance T1, the distance H1, and the curvature radius R1. The infiltration of the plating solution and the occurrence of chipping may be confirmed by observing the cross-section of one specimen newly randomly selected from the plurality of specimens.

The presence or absence of infiltration of the plating solution is determined based on whether the plating solution is present at an interface between the element body 3 and the external electrode 5. A specimen in which the plating solution is not present at the interface is determined as “Good (G)”. A specimen in which the plating solution is present at the interface is determined as “Fail (F)”. The presence or absence of infiltration of the plating solution may be determined based on whether an element constituting the plating layer is present at the above-described interface.

The presence or absence of occurrence of chipping is determined based on whether the chipping is present in the region R₃ₐ₁ or in the vicinity of the region R₃ₐ₁, of the main surface 3a. A specimen in which the chipping is not present is determined as “Good (G)”. A specimen in which the chipping is present is determined as “Fail (F)”.

As illustrated in FIG. 6, as a result of the test described above, it was confirmed that in the samples 1 to 7, the rate of change in the electrostatic capacitance was sufficiently low. That is, in the samples 1 to 7, it was confirmed that the deterioration of characteristics was controlled. In the samples 1 to 3 and the samples 5 to 7, it was confirmed that the infiltration of the plating solution was controlled. In the samples 1 to 4, the sample 6, and the sample 7, it was confirmed that the chipping tended not to occur.

Next, the relations between the distance T1, the distance H2, and the curvature radius R2 will be described in detail.

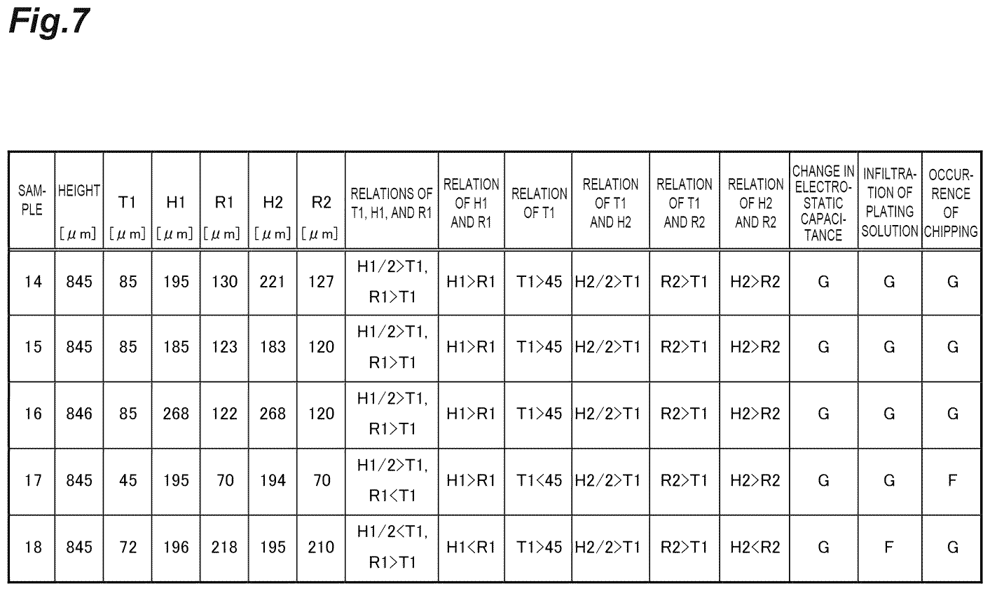

In order to clarify the relations between the distance T1, the distance H2, and the curvature radius R2, the present inventors conducted the following test. In this test, the present inventors prepared samples 14 to 18 with different distance T1, distance H2, and curvature radius R2, and confirmed changes in characteristics, infiltration of a plating solution, and occurrence of chipping, in each of the samples 14 to 18. The results are illustrated in FIG. 7. FIG. 7 is a table illustrating the test results of the samples.

Each of the samples 14 to 18 is a lot including a plurality of specimens. The specimens of the samples 14 to 18 are multilayer feedthrough capacitors having the same configuration as each other, except that the distance T1, the distances H1 and H2, and the curvature radii R1 and R2 are different between the specimens, and the height of the element body 3 and the number of the plurality of internal conductors are different between the specimens. In the specimens of the samples 14 to 18, the length of the element body 3 is 2.0 mm, and the width of the element body 3 is 1.2 mm.

In each specimen of the sample 14, the height of the element body 3 is 845 μm, the distance T1 is 85 μm, the distance H1 is 195 μm, and the curvature radius R1 is 130 μm. The distance H2 is 221 μm, and the curvature radius R2 is 127 μm.

In each specimen of the sample 15, the height of the element body 3 is 845 μm, the distance T1 is 85 μm, the distance H1 is 185 μm, and the curvature radius R1 is 123 μm. The distance H2 is 183 μm, and the curvature radius R2 is 120 μm.

In each specimen of the sample 16, the height of the element body 3 is 846 μm, the distance T1 is 85 μm, the distance H1 is 268 μm, and the curvature radius R1 is 122 μm. The distance H2 is 268 μm, and the curvature radius R2 is 120 μm.

In each specimen of the sample 17, the height of the element body 3 is 845 μm, the distance T1 is 45 μm, the distance H1 is 195 μm, and the curvature radius R1 is 70 μm. The distance H2 is 194 μm, and the curvature radius R2 is 70 μm.

In each specimen of the sample 18, the height of the element body 3 is 845 μm, the distance T1 is 72 μm, the distance H1 is 196 μm, and the curvature radius R1 is 218 μm. The distance H2 is 195 μm, and the curvature radius R2 is 210 μm.

The values of the distance T1, the distances H1 and H2, and the curvature radii R1 and R2 were obtained from one specimen randomly selected from the plurality of specimens in each of the samples 14 to 18 according to the above-described method.

The changes in characteristics are confirmed as follows.

The rate of change in the electrostatic capacitance of each of the samples 14 to 18 before and after the flexural strength test is obtained in the same manner as in the samples 1 to 13. For a specimen having a rate of change in the electrostatic capacitance of less than 5%, a situation of change in characteristics is determined as “Good (G)”. For a specimen having a rate of change in the electrostatic capacitance of 5% or more, a situation of change in characteristics is determined as “Fail (F)”.

The infiltration of the plating solution and the occurrence of chipping are confirmed by observing the cross-section of the specimen when obtaining the values of the distance T1, the distance H1, and the curvature radius R1, and by observing the cross-section of the specimen when obtaining the values of the distance H2 and the curvature radius R2. The infiltration of the plating solution and the occurrence of chipping may be confirmed by observing the cross-section of one specimen newly randomly selected from the plurality of specimens.

The presence or absence of infiltration of the plating solution is determined based on whether the plating solution is present at the interface between the element body 3 and the external electrode 5, and whether the plating solution is present at the interface between the element body 3 and the external electrode 6. In the same manner as in the samples 1 to 13, a specimen in which the plating solution is not present at the interface is determined as “Good (G)”. A specimen in which the plating solution is present at the interface is determined as “Fail (F)”.

The presence or absence of occurrence of the chipping is determined based on whether the chipping is present in the region R₃ₐ₁ or in the vicinity of the region R₃ₐ₁, of the main surface 3a, and whether the chipping is present in the region R₃ₐ₂ or in the vicinity of the region R₃ₐ₂, of the main surface 3a. In the same manner as in the samples 1 to 13, a specimen in which the chipping is not present is determined as “Good (G)”. A specimen in which the chipping is present is determined as “Fail (F)”.

As illustrated in FIG. 7, as a result of the test described above, it was confirmed that in the samples 14 to 18, the rate of change in the electrostatic capacitance was sufficiently low. That is, in the samples 14 to 18, it was confirmed that the deterioration of characteristics was controlled. In the samples 14 to 17, it was confirmed that the infiltration of the plating solution was controlled. In the sample 18, the plating solution was present at the interface between the element body 3 and the external electrode 5 and the interface between the element body 3 and the external electrode 6. In the samples 14 to 16, and the sample 18, it was confirmed that the chipping tended not to occur.

In the multilayer feedthrough capacitor C1 solder-mounted on the electronic device, a stress acts on the element body 3 from, for example, an end included in the external electrode 5 and positioned on the main surface 3a. In this case, a crack occurs in the element body 3 from, as a starting point, a position corresponding to the end included in the external electrode 5 and positioned on the main surface 3a. For example, the crack grows from the above-described starting point toward the end surface 3e in a direction intersecting the plane PL1. In a configuration in which an angle of the direction in which the crack grows in the element body 3 relative to the plane PL1 is large, the crack tends to reach, for example, the internal electrodes 7 and 9. In a configuration in which this angle is small, the crack tends not to reach, for example, the internal electrodes 7 and 9.

In the multilayer feedthrough capacitor C1, the distance T1 (μm), the distance H1 (μm), and the curvature radius R1 (μm) satisfy the relations of

$$H 1 / 2 > T 1$$

$$and$$

$$R 1 > T 1.$$

Therefore, the crack tends not to reach, for example, the internal electrode 7 and 9 even if the crack occurs in the element body 3. Consequently, the multilayer feedthrough capacitor C1 controls the deterioration of characteristics.

In the multilayer feedthrough capacitor C1, the reason why the crack caused by the external electrode 5 tends not to reach, for example, the internal electrodes 7 and 9 is considered to be based on the following events.

In the multilayer feedthrough capacitor C1 in which the distance T1 and the curvature radius R1 satisfy the relation of

$$R 1 > T 1 ,$$

molten solder tends to flow between the external electrode 5 and a pad electrode of the electronic device in solder-mounting, as compared with a multilayer feedthrough capacitor that does not satisfy this relation. Therefore, in the multilayer feedthrough capacitor C1, the amount of solder flowing between the external electrode 5 and the pad electrode of the electronic device tends to increase, and the size of a solder fillet tends to decrease. As the size of the solder fillet decreases, the position where the external force from the electronic device acts on the multilayer feedthrough capacitor C1 tends to be lower. When the position where the external force from the electronic device acts on the multilayer feedthrough capacitor C1 is low, the angle of the direction in which the crack caused by the external electrode 5 grows in the element body 3 tends to be small.

In the multilayer feedthrough capacitor C1 in which the distance T1 and the distance H1 satisfy the relation of

$$H 1 / 2 > T 1 ,$$

the internal electrode (for example, the internal electrode 7), of the plurality of internal electrodes, closest to the plane PL1 tends to be away from the plane PL1, as compared with a multilayer feedthrough capacitor that does not satisfy this relation. Therefore, the crack tends not to reach the internal electrode (for example, the internal electrodes 7 and 9) even if the crack grows in the element body 3.

In the multilayer feedthrough capacitor C1, the external electrode 5 includes the first electrode layer E1 and the second electrode layer E2. The second electrode layer E2 is formed through a plating process. In the plating process, for example, the element body 3 on which the first electrode layer E1 is disposed is immersed in a plating solution. In this case, the plating solution may infiltrate into the element body 3. The plating solution infiltrates into the element body 3 from, for example, the end 7e of the internal electrode 7 or the interface between the end 7e and the element body 3. In the multilayer feedthrough capacitor C1 with the element body 3 into which the plating solution has infiltrated, the characteristics may deteriorate.

In the multilayer feedthrough capacitor C1 in which the main surface 3a is curved at the end coupled to the end surface 3e, a thickness of the first electrode layer E1 tends to decrease at the above-described end of the main surface 3a. In this case, the plating solution tends to infiltrate from a region corresponding to the above-described end of the main surface 3a in the first electrode layer E1.

In the configuration in which the distance H1 (μm) and the curvature radius R1 (μm) satisfy the relation of

$$H 1 > R 1 ,$$

the plating solution tends not to infiltrate into the element body 3. Therefore, the multilayer feedthrough capacitor C1 having this configuration reliably controls the deterioration of characteristics.

In the configuration in which the curvature radius R1 is larger than the curvature radius at the end included in the end surface 3e and coupled to the main surface 3b, the main surface 3a and the main surface 3b are reliably identified from each other. Therefore, the multilayer feedthrough capacitor C1 having this configuration can be solder-mounted on the electronic device such that the main surface 3a reliably opposes the electronic device.

In the multilayer feedthrough capacitor C1 solder-mounted on the electronic device, the stress acts on the element body 3 from, for example, the end included in the external electrode 6 and positioned on the main surface 3a. In this case, a crack occurs in the element body 3 from, as a starting point, a position corresponding to the end included in the external electrode 6 and positioned on the main surface 3a. For example, the crack grows from the above-described starting point toward the side surface 3c in a direction intersecting the plane PL1. In a configuration in which an angle of the direction in which the crack grows in the element body 3 relative to the plane PL1 is large, the crack tends to reach, for example, the internal electrodes 7 and 9. In a configuration in which this angle is small, the crack tends not to reach, for example, the internal electrodes 7 and 9.

In the configuration in which the distance T1 (μm) and the distance H2 (μm) satisfy the relation of

$$H 2 / 2 > T 1 ,$$

the crack tends not to reach, for example, the internal electrodes 7 and 9 even if the crack caused by the external electrode 6 occurs in the element body 3. Therefore, the multilayer feedthrough capacitor C1 having this configuration further controls the deterioration of characteristics.

In the multilayer feedthrough capacitor C1, the reason why the crack caused by the external electrode 6 tends not to reach, for example, the internal electrodes 7 and 9 is considered to be based on the following events.

In the multilayer feedthrough capacitor C1 in which the distance T1 and the distance H2 satisfy the relation of

$$H 2 / 2 > T 1 ,$$

the internal electrode (for example, the internal electrode 9), of the plurality of internal electrodes, closest to the plane PL1 tends to be away from the plane PL1, as compared with a multilayer feedthrough capacitor that does not satisfy this relation. Therefore, the crack tends not to reach the internal electrode (for example, the internal electrodes 7 and 9) even if the crack grows in the element body 3.

In the configuration in which the distance T1 (μm) and the curvature radius R2 (μm) satisfy the relation of

$$R 2 > T 1 ,$$

the crack further tends not to reach, for example, the internal electrodes 7 and 9 even if the crack caused by the external electrode 6 occurs in the element body 3. The multilayer feedthrough capacitor C1 having this configuration further controls the deterioration of characteristics.

In the multilayer feedthrough capacitor C1, the reason why the crack caused by the external electrode 6 tends not to reach, for example, the internal electrodes 7 and 9 is considered to be based on the following events.

In the multilayer feedthrough capacitor C1 in which the distance T1 and the curvature radius R2 satisfy the relation of

$$R 2 > T 1 ,$$

molten solder tends to flow between the external electrode 6 and a pad electrode of the electronic device in solder-mounting, as compared with a multilayer feedthrough capacitor that does not satisfy this relation. Therefore, in the multilayer feedthrough capacitor C1, the amount of solder flowing between the external electrode 6 and the pad electrode of the electronic device tends to increase, and the size of a solder fillet tends to decrease. As the size of the solder fillet decreases, the position where the external force from the electronic device acts on the multilayer feedthrough capacitor C1 tends to be lower. When the position where the external force from the electronic device acts on the multilayer feedthrough capacitor C1 is low, the angle of the direction in which the crack caused by the external electrode 6 grows in the element body 3 tends to be small.

In the multilayer feedthrough capacitor C1, the external electrode 6 includes the first electrode layer E1 and the second electrode layer E2. The second electrode layer E2 is formed through a plating process. In the plating process, for example, the element body 3 on which the first electrode layer E1 is disposed is immersed in a plating solution. In this case, the plating solution may infiltrate into the element body 3. The plating solution infiltrates into the element body 3 from, for example, the end 9e of the internal electrode 9 or the interface between the end 9e and the element body 3. In the multilayer feedthrough capacitor C1 with the element body 3 into which the plating solution has infiltrated, the characteristics may deteriorate.

In the multilayer feedthrough capacitor C1 in which the main surface 3a is curved at the end coupled to the side surface 3e, a thickness of the first electrode layer E1 tends to decrease at the above-described end of the main surface 3a. In this case, the plating solution tends to infiltrate from a region corresponding to the above-described end of the main surface 3a in the first electrode layer E1.

In the configuration in which the distance H2 (μm) and the curvature radius R2 (μm) satisfy the relation of

$$H 2 > R 2 ,$$

the plating solution tends not to infiltrate into the element body 3. Therefore, the multilayer feedthrough capacitor C1 having this configuration reliably controls the deterioration of characteristics.

In the configuration in which the curvature radius R2 is larger than the curvature radius at the end included in the side surface 3c and coupled to the main surface 3b, the main surface 3a and the main surface 3b are also reliably identified from each other. Therefore, the multilayer feedthrough capacitor C1 having this configuration can be solder-mounted on the electronic device such that the main surface 3a further reliably opposes the electronic device.

In a manufacturing process, chipping may occur in the element body 3. For example, an impact is applied to the element body 3 because of collision between the element bodies 3 or collision between the element body 3 and manufacturing equipment other than the element body 3. An impact applied to the element body 3 increases a possibility that the chipping occurs in the element body 3.

The configuration in which the distance T1 (μm) satisfies the relation of

$$T 1 > 45 ,$$

controls occurrence of the chipping in the element body 3.

In the configuration in which the plurality of internal electrodes 7 and 9 oppose each other in the direction in which the main surface 3a and the main surface 3b oppose each other, the characteristics tend to deteriorate if the crack occurs in the element body 3. However, as described above, the crack tends not to reach, for example, the internal electrodes 7 and 9 even if the crack occurs in the element body 3. Therefore, in the multilayer feedthrough capacitor C1 having this configuration, the deterioration of characteristics is reliably controlled.

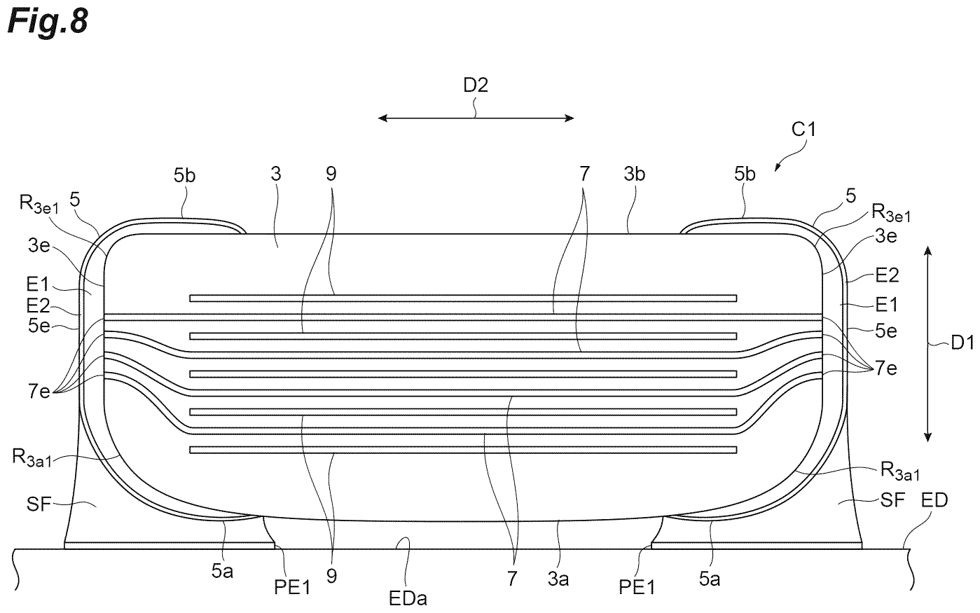

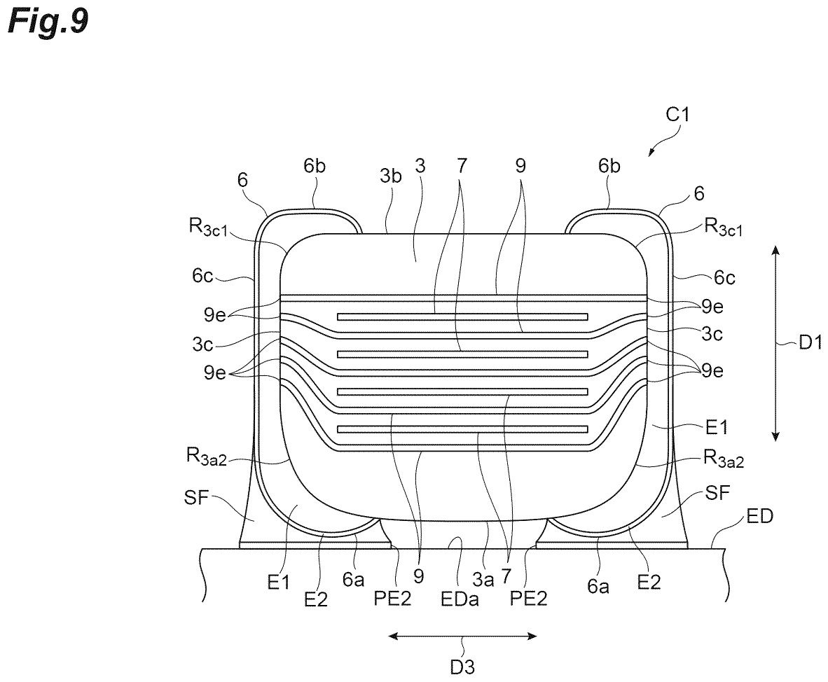

Next, a configuration of an electronic component device will be described with reference to FIGS. 8 and 9. FIGS. 8 and 9 are diagrams illustrating a cross-sectional configuration of an electronic component device. In FIGS. 8 and 9, hatching indicating the cross section is not illustrated.

The electronic component device includes the multilayer feedthrough capacitor C1 and an electronic device ED. The electronic device ED includes, for example, a circuit board or an other electronic component. The multilayer feedthrough capacitor C1 is solder-mounted on the electronic device ED. The electronic device ED includes a main surface EDa, a pair of pad electrodes PE1, and a pair of pad electrodes PE2. The pad electrodes PE1 and PE2 are disposed on the main surface EDa. The pair of pad electrodes PE1 and the pair of pad electrodes PE2 are separated from each other. The multilayer feedthrough capacitor C1 is disposed on the electronic device ED such that the main surface 3a and the main surface EDa oppose each other.

When the multilayer feedthrough capacitor C1 is solder-mounted, molten solder wets each of external electrodes 5 and 6 (second electrode layer E2). Solidification of the wet solder causes solder fillets SF to be formed on the external electrodes 5 and 6. The external electrode 5 and the pad electrode PE1 corresponding to each other are connected via the solder fillets SF. The external electrode 6 and the pad electrode PE2 corresponding to each other are connected via the solder fillets SF.

It is to be understood that not all aspects, advantages and features described herein may necessarily be achieved by, or included in, any one particular example. Indeed, having described and illustrated various examples herein, it should be apparent that other examples may be modified in arrangement and detail.

In the above-described example, the multilayer feedthrough capacitor has been described as an example of the electronic component, but an applicable electronic component is not limited to the multilayer feedthrough capacitor. The electronic component may include, for example, a normal multilayer capacitor instead of the multilayer feedthrough capacitor.

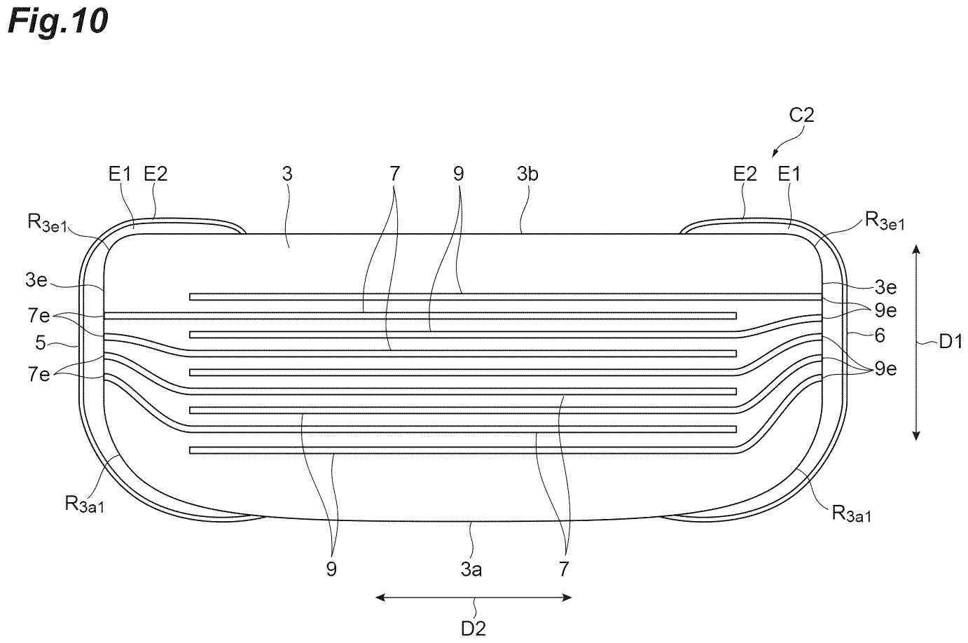

A configuration of a multilayer capacitor C2 will be described with reference to FIG. 10. FIG. 10 is a diagram illustrating a cross-sectional configuration of a multilayer capacitor according to a modification of the present example. In FIG. 10, hatching indicating the cross section is not illustrated.

As illustrated in FIG. 10, the multilayer capacitor CD2 includes an element body 3, a pair of external electrodes 5 and 6, a plurality of internal electrodes 7, and a plurality of internal electrodes 9. The pair of external electrodes 5 and 6 is disposed on both ends of the element body 3 in a second direction D2. The external electrode 5 is disposed on one end surface 3e of a pair of end surfaces 3e. The external electrode 6 is disposed on an other end surface 3e of the pair of end surfaces 3e.

The plurality of internal electrodes 7 are exposed at the one end surface 3e. Each internal electrode 7 includes an end 7e exposed at the one end surface 3e. The plurality of internal electrodes 7 are not exposed at the other end surface 3e. The plurality of internal electrodes 7 is physically and electrically connected to the external electrode 5. The plurality of internal electrodes 9 are exposed at the other end surface 3e. Each internal electrode 9 includes an end 9e exposed at the other end surface 3e. The plurality of internal electrodes 9 are not exposed at the one end surface 3e. The plurality of internal electrodes 9 is physically and electrically connected to the external electrode 6.

As understood from the test results of the samples 1 to 7, the multilayer capacitor C2 also controls the deterioration of characteristics.

The electronic component may include, instead of the multilayer capacitor C2, a multilayer capacitor that includes an element body 3, a pair of external electrodes disposed on both ends of the element body 3 in the third direction D3, and a plurality of internal electrodes each connected to a corresponding external electrode of the pair of external electrodes. The electronic component may include, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer capacitor.

What is claimed is:

1. An electronic component comprising:
an element body including a first main surface arranged to constitute a mounting surface, a second main surface opposing the first main surface, and an end surface coupling the first main surface and the second main surface;
a plurality of external electrodes disposed on the element body; and
a plurality of internal conductors disposed in the element body and including exposed ends exposed from the element body, wherein
the first main surface is curved at an end coupled to the end surface,
the plurality of external electrodes includes a first external electrode disposed on the first main surface and the end surface,
the plurality of internal conductors includes a plurality of first internal conductors with the exposed ends connected to the first external electrode, and
a distance T1 (μm), a distance H1 (μm), and a curvature radius R1 (μm) satisfy relations of
$$H 1 / 2 > T 1$$
$$and$$
$$R 1 > T 1 ,$$
the distance T1 being between an internal conductor, of the plurality of internal conductors, adjacent to the first main surface, and a plane in contact with the first main surface and parallel to the second main surface, in a direction perpendicular to the plane; the distance H1 being between an exposed end, of the exposed ends, connected to the first external electrode and closest to the plane, and the plane, in the direction perpendicular to the plane; and the curvature radius R1 being at the end included in the first main surface and coupled to the end surface.

2. The electronic component according to claim 1, wherein
the distance H1 (μm) and the curvature radius R1 (μm) satisfy a relation of
$$H 1 > R 1 .$$

3. The electronic component according to claim 1, wherein
the end surface is curved at an end coupled to the second main surface,
the first external electrode is also disposed on the second main surface, and
the curvature radius R1 is larger than a curvature radius at the end included in the end surface and coupled to the second main surface.

4. The electronic component according to claim 1, wherein
the element body includes a side surface coupling the first main surface and the second main surface and adjacent to the end surface,
the plurality of external electrodes includes a second external electrode disposed on the first main surface and the side surface,
the plurality of internal conductors includes a plurality of second internal conductors with the exposed ends connected to the second external electrode, and
the distance T1 (μm) and a distance H2 (μm) satisfy a relation of
$$H 2 / 2 > T 1 ,$$
the distance H2 being between an exposed end, of the exposed ends, connected to the second external electrode and closest to the plane, and the plane, in the direction perpendicular to the plane.

5. The electronic component according to claim 4, wherein
the first main surface is curved at an end coupled to the side surface, and
the distance T1 (μm) and a curvature radius R2 (μm) satisfy a relation of
$$R 2 > T 1 ,$$
the curvature radius R2 being at the end included in the first main surface and coupled to the side surface.

6. The electronic component according to claim 5, wherein
the distance H2 (μm) and the curvature radius R2 (μm) satisfy a relation of
$$H 2 > R 2 .$$

7. The electronic component according to claim 5, wherein
the side surface is curved at an end coupled to the second main surface,
the second external electrode is also disposed on the second main surface, and
the curvature radius R2 is larger than a curvature radius at the end included in the side surface and coupled to the second main surface.

8. The electronic component according to claim 1, wherein
the distance T1 (μm) satisfies a relation of
$$T 1 > 45 .$$

9. The electronic component according to claim 1, wherein
the plurality of internal conductors oppose each other in a direction in which the first main surface and the second main surface oppose each other.

10. An electronic component device comprising:
the electronic component according to claim 1; and
an electronic device in which the electronic component is solder-mounted, wherein
the first main surface opposes the electronic device.
